(19) United States
(12) Patent Application Publication
(10) Pub. No.: US 2011/0284245 A1
(43) Pub. Date: Nov. 24, 2011

(54) FLUID COMPOSITION COMPRISING PARTICLES AND METHOD OF MODIFYING A WELLBORE USING THE SAME

(76) Inventors: Michael D. Crandall, North Oaks, MN (US); Ignatius A. Kadoma, Cottage Grove, MN (US); Clara E. Mata, Lindstrom, MN (US); Yong K. Wu, Woodbury, MN (US)

(21) Appl. No.: 13/141,540

(22) PCT Filed: Dec. 21, 2009
(86) PCT No.: PCT/US09/68932

§ 371 Date: Jun. 22, 2011

Related U.S. Application Data
(60) Provisional application No. 61/140,406, filed on Dec. 23, 2008.

(51) Int. Cl. E21B 33/12; C09K 8/035

(52) U.S. Cl. 166/386; 507/117; 507/119

(57) ABSTRACT

Composition including a fluid and a plurality of solid particles dispersed in the fluid. The plurality of solid particles includes a thermoplastic composition having a softening temperature in a range from 50° C. to 180° C. and a curable resin; optionally at least some of the particles in the plurality of solid particles comprise both the thermoplastic composition and the curable resin. The solid particles have an average aspect ratio of less than 2:1. A method of modifying a wellbore within a geological formation is also disclosed. The method includes introducing the composition into the wellbore. A method of making a plurality of particles, for example, to use in the composition, is also disclosed.

### CROSS-REFERENCE TO RELATED APPLICATION

This application claims the benefit of U.S. Provisional Patent Application No. 61/140,406, filed Dec. 23, 2008, the disclosure of which is incorporated by reference herein in its entirety.

### BACKGROUND

Rotary drilling methods are commonly used in the drilling of oil and gas wells. Typically, the wellbore which extends from the surface into one or more subterranean oil and/or gas producing formations is drilled by a rotary drilling rig on the surface which rotates a drill bit attached to a string of drill pipe. The drill bit includes rotatable cutting surfaces so that when the drill bit is rotated by the drill string against subterranean strata under pressure a bore hole is produced.

Typically, a drilling fluid is circulated downwardly through the drill string, through the drill bit and upwardly in the annulus between the walls of the wellbore and the drill string. The drilling fluid functions to maintain hydrostatic pressure on formations penetrated by the wellbore, which helps to prevent pressurized formation fluids from flowing into the wellbore, and to remove cuttings from the wellbore. As the drilling fluid is circulated, a filter cake of solids from the drilling fluid forms on the walls of the wellbore, which may result from initial fluid loss to the formation and may prevent additional fluid loss. The drilling fluid also cools and lubricates the drill bit.

The hydrostatic pressure created by the drilling fluid in the wellbore may fracture weak formations penetrated by the wellbore which can cause drilling fluid to be lost into the formations. When this occurs, the drilling of the wellbore must be stopped to seal the fractures, which is a time-consuming and expensive process.

Another problem with drilling and completing wellbores occurs when the wellbore is drilled into and through unconsolidated weak zones or formations (e.g., formed of clays, shales, or sandstone). The unconsolidated portions of the formation can slough off the sides of the wellbore, which enlarges the wellbore and often causes the drill bit and drill pipe to become stuck. If this occurs, drilling must be stopped and remedial steps taken.

The problems that can occur with drilling become more frequent or pronounced with infield drilling, drilling below old fields, and striving for deeper targets. Each of these situations has become more common in recent years.

A typical technique for solving these problems that can occur during drilling includes putting a casing or liner into the wellbore and sealing the wellbore with, for example, cement in the annular space between the walls of the wellbore and the exterior surface of the casing or liner. This technique of cementing pipe in the wellbore as the drilling progresses has a number of disadvantages including the time and expense incurred in placing and sealing the pipe as well as the reduction in the wellbore diameter after each casing point. That is, the wellbore diameter must be reduced below each casing point so that a smaller casing can be lowered through the previously placed casing and sealed in the wellbore.

Thus, there are needs for improved methods of drilling wellbores and strengthening unconsolidated weak zones or fractures in a geological formation.

### SUMMARY

The present disclosure provides compositions that may be useful, for example, for strengthening weakly consolidated geological formations or geological formations fractured during the drilling process. The compositions may, in some embodiments, be added to the formation during the drilling process without removing the drilling fluid (e.g., with a preflush) and without equipment changeover. Advantageously, compositions and methods according to the present disclosure can be customized for individual wells and conditions (e.g., the depth and temperature of the geological formation).

In one aspect, the present disclosure provides a composition comprising a fluid and a plurality of solid particles dispersed in the fluid, wherein the plurality of solid particles comprises a thermoplastic composition having a softening temperature in a range from 50° C. to 180° C. and a curable resin, wherein optionally at least some of the particles in the plurality of solid particles comprise both the thermoplastic composition and the curable resin, and wherein the solid particles have an average aspect ratio of less than 2:1.

In another aspect, the present disclosure provides a method of modifying a wellbore within a geological formation, the method comprising:

introducing the composition according to the present disclosure into the wellbore;

subjecting the thermoplastic composition to a temperature above its softening temperature; and

at least partially curing the curable resin to form a plug in the wellbore.

In some embodiments, subjecting the thermoplastic composition to a temperature above its softening temperature and at least partially curing the curable resin are subsequent to introducing the composition into the wellbore.

In another aspect, the present disclosure provides a method of making a plurality of particles, the method comprising:

selecting a zone of a geological formation to be drilled, the zone having a target depth and a temperature;

receiving data comprising the target depth and the temperature of the zone of the geological formation;

generating a formulation comprising a thermoplastic composition and a curable resin, wherein the thermoplastic composition is selected based at least partially on its softening temperature being below the temperature in the zone, and wherein the formulation is generated based at least partially on its gelling after the target depth is reached; and

making the plurality of particles according to the formulation, wherein at least a portion of the plurality of particles comprises the thermoplastic composition, wherein at least a portion of the plurality comprises the curable resin.

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list and any combination of two or more items in the list.

The term “geological formation” includes both geological formations in the field (i.e., subterranean geological formations) and portions of such geological formations (e.g., core samples).

The term “introducing” includes placing a composition within a geological formation using any suitable manner known in the art (e.g., pumping, injecting, pouring, releasing, displacing, spotting, or circulating the fluorinated polymer into a well, wellbore, or geological formation).

All numerical ranges are inclusive of their endpoints unless otherwise stated.

### BRIEF DESCRIPTION OF THE DRAWING

For a more complete understanding of the features and advantages of the present disclosure, reference is now made to the detailed description along with the accompanying figures and in which:

FIG. 1 is a chart of a typical wellbore temperature profile at different depths, pumping times, and drilling rates; and

FIG. 2 is a chart of the temperature profile expected for the plurality of particles of Example 1 plotted against a typical wellbore temperature profile at different depths, pumping times, and drilling rates.

### DETAILED DESCRIPTION

Compositions according to the present disclosure comprise a plurality (i.e., multiple) of solid particles dispersed in a fluid. The plurality of solid particles comprises a thermoplastic composition and a curable resin, wherein optionally at least some of the particles in the plurality of solid particles comprise both the thermoplastic composition and the curable resin. In some embodiments, particles useful in practicing the present disclosure may comprise either the thermoplastic composition or the curable resin. For example, the plurality of particles may contain particles of more than one composition, wherein the thermoplastic composition and the curable resin are in separate solid particles of the plurality of solid particles. In some embodiments, at least some of the particles in the plurality of solid particles comprise both the thermoplastic composition and the curable resin. In some of these embodiments, the thermoplastic composition and the curable resin form an interpenetrating network (e.g., after the curable resin is cured). In other embodiments of the plurality of solid particles disclosed herein, at least some of the particles in the plurality of solid particles comprise both the thermoplastic composition and the curable resin in an admixture, for example, wherein the curable resin is uniformly mixed with a thermoplastic. In some embodiments, at least some of the particles disclosed herein have the thermoplastic composition and the curable resin in separate regions of the same particle, for example, if the curable resin is coated on the surface of a thermoplastic particle.

The solid particles useful for practicing the present disclosure typically have a low aspect ratio. The average aspect ratio of solid particles described herein may be, for example, less than 2:1 or up to 2:1, 1.9:1, 1.8:1, 1.7:1, 1.6:1, 1.5:1, 1.4:1, 1.3:1, 1.2:1, or 1.1:1. The solid particles, in some embodiments, have an average particle size of up to 4, 3, 2, 1.5, or 1 millimeters (mm). For example, the solid particles may have an average particle size in a range from 0.100 mm to 3 mm (i.e., about 140 mesh to about 5 mesh (ANSI)) (in some embodiments, in a range from 1 mm to 3 mm, 1 mm to 2 mm, 1 mm to 1.7 mm (i.e., about 18 mesh to about 12 mesh), 0.85 mm to 1.7 mm (i.e., about 20 mesh to about 12 mesh), 0.85 mm to 1.2 mm (i.e., about 20 mesh to about 16 mesh), 0.6 mm to 1.2 mm (i.e., about 30 mesh to about 16 mesh), 0.425 mm to 0.85 mm (i.e., about 40 to about 20 mesh), or 0.3 mm to 0.600 mm (i.e., about 50 mesh to about 30 mesh). The particles may be spherical or non-spherical (e.g., having a prismatic, cylindrical, lobed, polygonal, or a rectangular cross-section). The particles may be hollow or not hollow. Differences in cross-sectional shape allow for control of active surface area, mechanical properties, and interaction with fluid or other components. In some embodiments, the particles useful for practicing the present disclosure has a circular cross-section or a rectangular cross-section.

Typically, the dimensions of the particles in the plurality of solid particles are generally about the same, although use of particles with even significant differences dimensions may also be useful. In some applications, it may be desirable to use multiple different types of particles (e.g., having at least one different polymer or resin, one or more additional polymers, different average sizes, or otherwise distinguishable constructions), where one type offers a certain advantage(s) in one aspect, and other type a certain advantage(s) in another aspect.

Typically, the plurality of solid particles described herein exhibit at least one of (in some embodiments both) hydrocarbon or hydrolytic resistance. In some embodiments, when a 5 percent by weight mixture of the plurality of particles in deionized water is heated at 145° C. for four hours in an autoclave, less than 50% by volume of the plurality of solid particles at least one of dissolves or disintegrates, and less than 50% by volume of the thermoplastic composition and the curable resin at least one of dissolves or disintegrates. Specifically, hydrolytic resistance is determined using the following procedure. One-half gram of particles is placed into a 12 mL vial containing 10 grams of deionized water. The vial is nitrogen sparged, sealed with a rubber septum and placed in an autoclave at 145° C. for 4 hours. The particles are then subjected to optical microscopic examination at 100× magnification. They are deemed to have failed the test if either at least 50 percent by volume of the particles or at least 50 percent by volume of the thermoplastic composition and the curable resin dissolved and/or disintegrated.

In some embodiments, when a 2 percent weight to volume mixture of the plurality of solid particles in kerosene is heated at 145° C. for 24 hours under nitrogen, less than 50% by volume of the plurality of solid particles at least one of dissolves or disintegrates, and less than 50% by volume of the thermoplastic composition and the curable resin at least one of dissolves or disintegrates. Specifically, hydrocarbon resistance is determined using the following procedure. One-half gram of particles is placed into 25 mL of kerosene (reagent grade, boiling point 175-320° C., obtained from Sigma-Aldrich, Milwaukee, Wis.), and heated to 145° C. for 24 hours under nitrogen. After 24 hours, the kerosene is cooled, and the particles are examined using optical microscopy at 100× magnification. They are deemed to have failed the test if either at least 50 percent by volume of the particles or at least 50 percent by volume of the thermoplastic composition and the curable resin dissolved and/or disintegrated.

The plurality of solid particles according to the present disclosure comprises a thermoplastic composition having a softening temperature in a range from 50° C. to 180° C. (in some embodiments, in a range from 70° C. to 180° C., 80° C. to 180° C., 80° C. to 170° C., 80° C. to 160° C., 80° C. to 150° C., or 80° C. to 140° C., 90° C. to 180° C., 90° C. to 160° C., 100° C. to 180° C., 100° C. to 160° C., or 100° C. to 150° C.). For any of the embodiments of the plurality of solid particles disclosed herein, the thermoplastic composition may be a single thermoplastic material, a blend of thermoplastic materials, or a blend of at least one thermoplastic and at least one other (i.e., non-thermoplastic) material. The desired softening temperature can be achieved by selecting an appropriate single thermoplastic material or combining two or more thermoplastic materials. For example, if a thermoplastic material softens at too high of a temperature for a particular application, it can be decreased by adding a second thermoplastic with a lower softening temperature. Also, a thermoplastic material may be combined with, for example, a plasticizer to achieve the desired softening temperature. In some embodiments, the curable resin may be admixed with a thermoplastic, and the resulting admixture has a softening temperature in a range from 50° C. to 180° C. (in some embodiments, in a range from 70° C. to 180° C., 80° C. to 180° C., 80° C. to 170° C., 80° C. to 160° C., 80° C. to 150° C., or 80° C. to 140° C., 90° C. to 180° C., 90° C. to 160° C., 100° C. to 180° C., 100° C. to 160° C., or 100° C. to 150° C.).

Exemplary thermoplastics that have or may be modified to have a softening temperature in a range from 50° C. to 180° C. (in some embodiments, in a range from 70° C. to 180° C., 80° C. to 180° C., 80° C. to 170° C., 80° C. to 160° C., 80° C. to 150° C., or 80° C. to 140° C., 90° C. to 180° C., 90° C. to 160° C., 100° C. to 180° C., 100° C. to 160° C., or 100° C. to 150° C.) include at least one of ethylene-vinyl alcohol copolymer (e.g., with softening temperature of 156 to 191° C., available from EVAL America, Houston, Tex., under the trade designation “EVAL G176B”), thermoplastic polyurethane (e.g., available from Huntsman, Houston, Tex., under the trade designation “IROGRAN”, e.g., “IROGRAN A80 P4699”), polyoxymethylene (e.g., available from Ticona, Florence, Ky., under the trade designation “CELCON”, e.g., “CELCON FG40U01”), polypropylene (e.g., available from Total, Paris, France, e.g., under the trade designation “5571”), polyolefins (e.g., available from ExxonMobil, Houston, Tex., under the trade designation “EXACT 8230”), ethylene-vinyl acetate copolymer (e.g., available from AT Plastics, Edmonton, Alberta, Canada), polyester (e.g., available from Evonik, Parsippany, N.J., under the trade designation “DYNAPOL” or from EMS-Chemie AG, Reichenauerstrasse, Switzerland, under the trade designation “GRILTEX”), polyamides (e.g., available from Arizona Chemical, Jacksonville, Fla., under the trade designation “UNIREZ 2662” or from E. I. du Pont de Nemours, Wilmington, Del., under the trade designation “ELVAMIDE”, e.g. “ELVAMIDE 8660”, or from BASF North America, Florham Park, N.J., under the trade designation “ULTRAMID”), phenoxy (e.g., from Inchem, Rock Hill S.C.), vinyls (e.g., polyvinyl chloride form Omnia Plastica, Arsizio, Italy), acrylics (e.g., from Arkema, Paris, France, under the trade designation “LOTADERAX 8900”), polysulfone, polyimide, polyetheretherketone, or polycarbonate. In some embodiments, the thermoplastic composition comprises a partially neutralized ethylene-methacrylic acid copolymer commercially available, for example, from E. I. duPont de Nemours & Company, under the trade designations “SURLYN 8660,” “SURLYN 1702,” “SURLYN 1857,” and “SURLYN 9520”). In some embodiments, the thermoplastic composition comprises at least one of a polyurethane, a polyamide, a polyester, a polycarbonate, a polylactic acid, an acrylic, a polyimide, or an ionomer. In some embodiments, the thermoplastic composition comprises a mixture of a thermoplastic polyurethane obtained from Huntsman under the trade designation “IROGRAN A80 P4699”, a hot melt adhesive obtained from 3M Company, St. Paul, Minn. under the trade designation “3M SCOTCH-WELD HOT MELT ADHESIVE 3789”, and a polyoxymethylene obtained from Ticona under the trade designation “CELCON FG40U01”. In some embodiments, the plurality of solid particles further comprises a polyolefin obtained from ExxonMobil Chemical under the trade designation “EXACT 8230”.

In some embodiments, including any of the embodiments of a plurality of solid particles disclosed herein, the thermoplastic composition has a modulus of less than 3×10⁶ dynes/cm² (3×10⁵ N/m²) at a frequency of about 1 Hz at a temperature greater than −60° C. In these embodiments, typically the first thermoplastic composition is tacky at the temperature greater than −60° C.

The plurality of solid particles disclosed herein comprises a curable resin (i.e., a thermosetting resin). The term “curable” as used herein refers to toughening or hardening of a resin by covalent crosslinking, brought about by at least one of chemical additives, electromagnetic radiation (e.g. visible, infrared or ultraviolet), e-beam radiation, or heat. Curable resins include low molecular weight materials, prepolymers, oligomers, and polymers, for example, having a molecular weight in a range from 500 to 5000 grams per mole. Useful curable resins include liquids and solids, for example, having a melting point of at least 50° C. (in some embodiments, at least 60° C., 70° C., or 80° C., in some embodiments, up to 100° C., 110° C., or 120° C.). Liquid curable resins may be admixed, for example, with thermoplastic materials to provide solid particles. Exemplary curable resins include at least one of epoxy (e.g., available from Hexion Specialty Chemicals, Houston, Tex., under the trade designations “EPON 2004”, “EPON 828”, or “EPON 1004”), phenolic (e.g., available from Georgia Pacific, Atlanta, Ga.), acrylic, isocyanate (e.g., available from Bayer, Pittsburgh, Pa.), phenoxy (e.g., available from Inchem Corp), vinyls, vinyl ethers, or silane (e.g., available from Dow-Corning, Midland, Mich.).

In some embodiments, including any of the embodiments of the plurality of solid particles disclosed herein, the curable resin is an epoxy resin. Useful epoxy resins generally have, on the average, at least two epoxy groups per molecule. The “average” number of epoxy groups per molecule is defined as the number of epoxy groups in the epoxy-containing material divided by the total number of epoxy molecules present. In some embodiments the plurality of solid particles disclosed herein, the curable resin is a solid epoxy resin. Suitable epoxy resins include the diglycidyl ether of Bisphenol A (e.g., those available from Hexion Specialty Chemicals under the trade designations “EPON 828”, “EPON 1004”, and “EPON 1001F” and from Dow Chemical Co., Midland, Mich. under the trade designations “D.E.R. 332” and “D.E.R. 334”), the diglycidyl ether of Bisphenol F (e.g., available from Huntsman Chemical, The Woodlands, Tex., under the trade designation “ARALDITE GY28 1”), cycloaliphatic epoxies (e.g., vinylcyclohexene dioxide, 3,4-epoxycyclohexylmethyl-3,4-epoxycyclohexene carboxylate, 2-(3,4-epoxycylohexyl-5,5-spiro-3,4-epoxy) cyclohexane-metadioxane, bis(3,4-epoxycyclohexyl) adipate, and those available from Dow Chemical Co. under the trade designation “ERL”); epoxidized polybutadiene; silicone resin containing epoxy functionality, flame retardant epoxy resins (e.g., a brominated bisphenol type epoxy resin available, for example, from Dow Chemical Co. under the trade designation “D. E. R. 542”), 1,4-butanediol diglycidyl ether (e.g., available from Huntsman Chemical under the trade designation “ARALDITE RD-2”), diglycidyl ethers of polyoxyalkylene glycols, hydrogenated bisphenol A-epichlorohydrin based epoxy resins (e.g., available from Hexion Specialty Chemicals under the trade designation “EPONEX 1510”), polyglycidyl ether of phenolformaldehyde novolak (e.g., available from Dow Chemical Co. under the trade designation “D.E.N. 431” and “D.E.N. 438”), and glycidyl methacrylate polymers or copolymers.

Embodiments of the plurality of solid particles described herein include those comprising a curing agent. The term “curing agent” refers to both reactive multifunctional materials that copolymerize with the curable resin (e.g., by addition polymerization) and components that cause the homopolymerization of the curable resin. Some curing agents may both copolymerize with curable resins and cause their homopolymerization, depending on the temperature and other conditions. In some embodiments, the curing agent is present, for example, with the curable resin and/or the thermoplastic composition described herein. In some embodiments, the thermoplastic composition comprises a curing agent. In some of these embodiments, the thermoplastic composition is formulated with, for example, a photoinitiator or catalyst that can cure the curable resin. In some embodiments, the thermoplastic composition includes a thermoplastic with a functional group (e.g., acidic or basic functional groups) that is reactive with (e.g., can cause the homopolymerization of) the curable resin. In some embodiments, the functional group is an amine, a carboxylic acid, or a hydroxyl group. In some embodiments, the thermoplastic composition includes a polyurethane. In other embodiments, the thermoplastic composition includes an ethylene methacrylic acid co-polymer.

Exemplary curing agents (e.g., for epoxy resins) include aromatic amines (e.g., 4,4′ methylene dianiline or an aromatic amine available, for example, from Air Products, Allentown, Pa., under the trade designation “AMICURE 101”); aliphatic amines (e.g., diethethylenetriamine, aminoethylpiperazine, or tetraethylenepentamine); modified aliphatic amines (e.g., those available from Air Products under the trade designations “ANCAMINE XT”, “ANCAMINE 1768”, or “ANCAMINE 2337S”); cycloaliphatic amines (e.g. those available from Air Products under the trade designations “ANCAMINE 1618” or “ANCAMINE 1895”; modified polyether amines (e.g., those available from Huntsman Chemical, The Woodlands, Tex., under the trade designation “JEFFAMINE”); amidoamines (e.g., those available from Air Products under the trade designations “ANCAMIDE 506”, “ANCAMIDE 2386”, or “ANCAMIDE 2426”); polyamides (e.g., those available from Air Products under the trade designations “ANCAMIDE 220”, “ANCAMIDE 260A”, and “ANCAMIDE 400”); tertiary amines (e.g., those available from Air Products under the trade designations “ANCAMINE 1110” and “ANCAMINE K54”); dicyandiamide; substituted ureas (e.g., those available from Air Products under the trade designations “AMICURE UR” and “AMICURE UR2T”; imidiazoles (e.g., those available from Shikoku Chemicals Corporation, Marugame, Kagawa, Japan under the trade designations “CUREZOL 2MA-OK” and “CUREZOL 2PZ”; boron trifluoride monoethylamine; quaternary phosphoneium salts; urethanes, anhydrides (e.g., maleic anhydride and succinic anhydride); carboxylic acids; polysulfides; and mercaptans (e.g., those available from Cognis Corporation, Monheim, Germany, under the trade designation “CAPCURE WR-6”. In some embodiments, the curing agent is a photoinitiator. Exemplary photoinitiators include aromatic iodonium complex salts (e.g., diaryliodonium hexafluorophosphate, diaryliodonium hexafluoroantimonate, and others described in U.S. Pat. No. 4,256,828 (Smith)); aromatic sulfonium complex salts (e.g., triphenylsulfonium hexafluoroantimonate and others described in U.S. Pat. No. 4,256,828 (Smith)); and metallocene salts (e.g., (η⁵-cyclopentadienyl)η⁶-xylenes)Fe⁺SbF₆⁻ and others described in U.S. Pat. No. 5,089,536 (Palazzotto).

In some embodiments, the curing agent is selected from the group consisting of amines, urethanes, ureas, amides, carboxylic acids, and imidazole. The curing agent may be present in the plurality of particles (e.g., with the curable resin or with the first thermoplastic composition) in a range from 0.1 to 40 percent by weight based on the amount of the curable resin, depending on the curing agent selected (e.g., whether it is a catalytic or stoichiometric curing agent). In some embodiments (e.g., embodiments wherein the thermoplastic composition includes a thermoplastic that is a curing agent) the weight of the curing agent can exceed the weight of the curable resin. Generally, the curing agent is present in a sufficient amount to cause the curable resin and any other components (e.g., thermoplastic) past the gel point.

Curable resins described herein can be cured using techniques known in the art, including through electromagnetic radiation (e.g. visible, infrared, or ultraviolet), e-beam radiation, heat, or a combination thereof. In some embodiments where a photoinitiator is a curing agent for the curable resin, the plurality of particles may be exposed to light and then exposed to heat (e.g., when the plurality of particles are introduced into a subterranean formation).

In some embodiments, the curable resin, in combination with any curative and/or accelerator, has an cure onset temperature of at least 80° C. (in some embodiments, at least 85° C., 90° C., 95° C., 100° C., 110° C., 120° C., 130° C., 140° C., 150° C., or at least 160° C. or in a range from 80° C. to 180° C.). The cure onset temperature can be adjusted, for example, by selection of the curative and/or accelerator, by selection of the thermoplastic composition, which may include a functional group that is reactive with the curable resin, and by selection of the ratio of the thermoplastic composition and the curable resin in the plurality of solid particles.

The plurality of solid particles described herein may, for example, comprise at least 30, 40, 50, 60, 70, 75, 80, 90, or at least 95 (in some embodiments, in a range from 35 to 80 or 45 to 75) percent by weight thermoplastic (e.g., including the thermoplastic composition and any other thermoplastics), based on the total weight of the plurality of solid particles. In some embodiments, the plurality of solid particles described herein may, for example, comprise in a range from 5 to 85 (in some embodiments, 5 to 40, 35 to 80, or 45 to 75) percent by weight of the first thermoplastic composition having a softening temperature in a range from 50° C. to 180° C. (in some embodiments, in a range from 70° C. to 180° C., 80° C. to 180° C., 80° C. to 170° C., 80° C. to 160° C., 80° C. to 150° C., or 80° C. to 140° C., 90° C. to 180° C., 90° C. to 160° C., 100° C. to 180° C., 100° C. to 160° C., or 100° C. to 150° C.), based on the total weight of the plurality of solid particles.

In some embodiments, the plurality of solid particles disclosed herein has the curable resin present in a range from 5 to 65 (in some embodiments, 10 to 60, or 15 to 55) percent by weight, based on the total weight of the plurality of solid particles.

Particles disclosed herein may be prepared, for example, using standard extrusion, pelletizing, milling, and grinding equipment.

Compositions according to the present disclosure may be aqueous, non-aqueous (e.g., comprising hydrocarbon or alcohol), or a combination thereof (e.g., an emulsion), and may optionally comprise one or more surfactants, viscosity modifiers (e.g., gelling agents and breakers), gases (e.g., nitrogen, carbon dioxide, air, and natural gas), buffers, or salts. The pH of the composition may be adjusted to be compatibility with the plurality of particles disclosed herein.

In some embodiments of compositions according to the present disclosure, the fluid is aqueous. In some embodiments of compositions according to the present disclosure, the fluid is a drilling fluid comprising hydrocarbons, which may include water-in-oil emulsions and oil-in-water emulsions. Exemplary hydrocarbons include crude oil; refined hydrocarbons (e.g., gasoline, kerosene, and diesel); paraffinic and isoparaffinic hydrocarbons (e.g., pentanes, hexanes, heptanes, higher alkanes, and isoparaffinic solvents obtained from Total Fina, Paris, France, under trade designations “ISANE IP 130” and “ISANE IP 175” and from Exxon Mobil Chemicals, Houston, Tex., under the trade designation “ISOPAR”); mineral oil; ligroin; naphthenes; aromatics (e.g., xylenes and toluene); natural gas condensates; and combinations (either miscible or immiscible) thereof. Typically drilling fluids that comprise hydrocarbons (i.e., oil-based drilling fluids) comprise mineral oil or diesel. Some drilling fluids comprising hydrocarbons are commercially available, for example, from SynOil under the trade designation “SYNDRIL” and from Baker Hughes, Houston, Tex., under the trade designations “CARBO-DRILL” and “CARBO-CORE”.

In some embodiments, the composition disclosed herein is a drilling fluid comprising a water-in-oil emulsion. A water-in-oil emulsion contains droplets of water or brine dispersed in hydrocarbons. Typically, water-in-oil emulsions contain at least one oil-mud emulsifier, which lowers the interfacial tension between oil and water and allows stable emulsions with small drops to be formed. Oil-mud emulsifiers can be calcium fatty-acid soaps made from various fatty acids and lime, or derivatives such as amides, amines, amidoamines and imidazolines made by reactions of fatty acids and various ethanolamine compounds.

Optionally, the plurality of solid particles described herein may further comprise other components (e.g., additives and/or coatings) to impart desirable properties such as handling, processability, stability, and dispersability and to improve performance when dispersed in a fluid. Exemplary additives and coating materials include antioxidants, colorants (e.g., dyes and pigments), fillers (e.g., carbon black, clays, and silica), and surface applied materials (e.g., waxes, surfactants, polymeric dispersing agents, talcs, erucamide, gums, and flow control agents) to improve handling.

Surfactants can be used to improve the dispersibility of particles described herein, for example, in compositions (e.g., comprising a fluid) according to the present disclosure. Useful surfactants (also known as emulsifiers) include anionic, cationic, amphoteric, and nonionic surfactants. Useful anionic surfactants include alkylarylether sulfates and sulfonates, alkylarylpolyether sulfates and sulfonates (e.g., alkylarylpoly(ethylene oxide) sulfates and sulfonates, preferably those having up to about 4 ethyleneoxy repeat units, including sodium alkylaryl polyether sulfonates such as those known under the trade designation “TRITON X200”, available from Rohm and Haas, Philadelphia, Pa.), alkyl sulfates and sulfonates (e.g., sodium lauryl sulfate, ammonium lauryl sulfate, triethanolamine lauryl sulfate, and sodium hexadecyl sulfate), alkylaryl sulfates and sulfonates (e.g., sodium dodecylbenzene sulfate and sodium dodecylbenzene sulfonate), alkyl ether sulfates and sulfonates (e.g., ammonium lauryl ether sulfate), and alkylpolyether sulfate and sulfonates (e.g., alkyl poly(ethylene oxide) sulfates and sulfonates, preferably those having up to about 4 ethyleneoxy units). Useful nonionic surfactants include ethoxylated oleoyl alcohol and polyoxyethylene octylphenyl ether. Useful cationic surfactants include mixtures of alkyl dimethylbenzyl ammonium chlorides, wherein the alkyl chain has from 10 to 18 carbon atoms. Amphoteric surfactants are also useful and include sulfobetaines, N-alkylaminopropionic acids, and N-alkylbetaines. Surfactants may be added to the particles disclosed herein, for example, in an amount sufficient on average to make a monolayer coating over the surfaces of the particles to induce spontaneous wetting. Useful amounts of surfactants may be in a range, for example, from 0.05 to 3 percent by weight, based on the total weight of the plurality of particles.

Polymeric dispersing agents may also be used, for example, to promote the dispersion of particles described herein in the chosen medium, and at the desired application conditions (e.g., pH and temperature). Exemplary polymeric dispersing agents include salts (e.g., ammonium, sodium, lithium, and potassium) of polyacrylic acids of greater than 5000 average molecular weight, carboxy modified polyacrylamides (available, for example, under the trade designation “CYANAMER A-370” from Cytec Industries, West Paterson, N.J.), copolymers of acrylic acid and dimethylaminoethylmethacrylate, polymeric quaternary amines (e.g., a quaternized polyvinyl-pyrollidone copolymer (available, for example, under the trade designation “GAFQUAT 755” from ISP Corp., Wayne, N.J.) and a quaternized amine substituted cellulosic (available, for example, under the trade designation “JR-400” from Dow Chemical Company, Midland, Mich.), cellulosics, carboxy-modified cellulosics (e.g., sodium carboxy methycellulose (available, for example, under the trade designation ““NATROSOL CMC Type 7L” from Hercules, Wilmington, Del.), and polyvinyl alcohols. Polymeric dispersing agents may be added to the particles disclosed herein, for example, in an amount sufficient on average to make a monolayer coating over the surfaces of the particles to induce spontaneous wetting. Useful amounts of polymeric dispersing agents may be in a range, for example, from 0.05 to 5 percent by weight, based on the total weight of the plurality of particles.

Examples of antioxidants which may be useful in the plurality of solid particles disclosed herein include hindered phenols (available, for example, under the trade designation “IRGANOX” from Ciba Specialty Chemical, Basel, Switzerland). Typically, antioxidants are used in a range from 0.1 to 1.5 percent by weight, based on the total weight of the plurality of particles, to retain useful properties during extrusion and through the life of the composition.

Compositions according to the present disclosure may further comprise a gelling agent (e.g., a phosphoric acid ester when the composition is a drilling fluid comprising hydrocarbons). In some of these embodiments, the composition further comprises an activator (e.g., a source of polyvalent metal ions) for the gelling agent. Gelling agents and activators useful in practicing the present disclosure are described, for example, in U.S. Pat. Nos. 4,622,155 (Harris et al.) and 5,846,915 (Smith et al.), the disclosures of which are incorporated herein by reference. In some embodiments wherein gelling agents are used, a suitable breaker may be included in or added to the composition so that the viscosity of the composition may eventually be reduced, for example, to recover it from the subterranean formation at a desired time. Suitable breakers include, for example, those described in U.S. Pat. No. 7,066,262 (Funkhouser), the disclosure of which is incorporated herein by reference.

In some embodiments, compositions according to the present disclosure comprise bridging particles (e.g., dispersed in the fluid). Bridging particles are sometimes used with drilling fluids in an effort to use fractures to cause stress changes in the rock. The fractures are held open with the bridging particles, and the bridging particles may be held together by the plug formed after the thermoplastic reaches its softening temperature and the curable resin is cured. Exemplary bridging particles known in the art include those made of sand (e.g., Ottawa, Brady or Colorado Sands, often referred to as white and brown sands having various ratios), resin-coated sand, sintered bauxite, ceramics (i.e., glasses, crystalline ceramics, glass-ceramics, and combinations thereof), thermoplastics, organic materials (e.g., ground or crushed nut shells, seed shells, fruit pits, and processed wood), and clay. Sand particles are available, for example, from Badger Mining Corp., Berlin, Wis.; Borden Chemical, Columbus, Ohio; and Fairmont Minerals, Chardon, Ohio. Thermoplastic particles are available, for example, from the Dow Chemical Company, Midland, Mich.; and BJ Services, Houston, Tex. Clay-based particles are available, for example, from CarboCeramics, Irving, Tex.; and Saint-Gobain, Courbevoie, France. Sintered bauxite ceramic particles are available, for example, from Borovichi Refractories, Borovichi, Russia; 3M Company, St. Paul, Minn.; CarboCeramics; and Saint Gobain. Glass bubble and bead particles are available, for example, from Diversified Industries, Sidney, British Columbia, Canada; and 3M Company.

Useful bridging particles have sizes, for example, in a range from 0.100 mm to 3 mm (i.e., about 140 mesh to about 5 mesh (ANSI)) (in some embodiments, in a range from 1 mm to 3 mm, 1 mm to 2 mm, 1 mm to 1.7 mm (i.e., about 18 mesh to about 12 mesh), 0.85 mm to 1.7 mm (i.e., about 20 mesh to about 12 mesh), 0.85 mm to 1.2 mm (i.e., about 20 mesh to about 16 mesh), 0.6 mm to 1.2 mm (i.e., about 30 mesh to about 16 mesh), 0.425 mm to 0.85 mm (i.e., about 40 to about 20 mesh), or 0.3 mm to 0.600 mm (i.e., about 50 mesh to about 30 mesh). In some embodiments, the average size of the bridging particles and the average size of the plurality of solid particles disclosed herein is about the same (e.g., within 20, 15, 10, or 5 percent).

The present disclosure provides a method of modifying a wellbore within a geological formation. The method comprises introducing into a wellbore penetrating the geological formation a composition disclosed herein (e.g., in any of the embodiments described above).

The method of modifying a wellbore within a geological formation disclosed herein also comprises subjecting the thermoplastic composition to a temperature above its softening temperature. Above the softening temperature, for example, at the temperature of the subterranean formation, the thermoplastic composition may become tacky (i.e., have a modulus of less than 3×10⁶ dynes/cm² (3×10⁵ N/m²) at a frequency of about 1 Hz), and the particles in plurality of particles can adhere to each other. The tacky network that may be formed almost instantaneously when the particles reach their desired position in the formation may be useful, for example, to hold bridging particles in place in the formation. In some embodiments, the thermoplastic composition is designed to be tacky at a specific downhole temperature (e.g., the bottomhole static temperature (BHST).

Also, above the softening temperature, the thermoplastic composition may begin to flow. In some embodiments, wherein the thermoplastic composition comprises a thermoplastic with a functional group that is reactive with the curable resin or wherein the thermoplastic composition comprises a curing agent for the curable resin, when the thermoplastic composition is exposed to a temperature above its softening temperature, onset of curing of the curable resin may occur. This may be advantageous, for example, for preventing curing of the resin before it is placed in the desired location in the subterranean formation. In some embodiments, the plurality of particles is designed to have a cure onset specific downhole temperature.

The method of modifying a wellbore within a geological formation disclosed herein also comprises at least partially curing the curable resin to form a plug in the wellbore. The term “plug” refers to a cross-linked network that is formed in the wellbore, for example, filling the wellbore, filling any fractures that are formed in the formation during the drilling of the wellbore and consolidating weak formations around the wellbore. The plug that is formed from the plurality of particles after curing the curable resin, which may include any bridging particles that were used in the composition, is typically designed to have low permeability, for example, to prevent fluid loss and to prevent drilling fluid from causing any further elongation of the fracture in the formation. In some embodiments, the thermoplastic present with the cured resin in the plug can toughen the consolidated formation or pack present in the fractures.

In the methods of modifying a wellbore described herein, at least partial curing of the curable resin refers to, for example, when at least 50 (in some embodiments, at least 60, 70, 75, 80, 90, 95, or 97) percent of the reactive functional groups in the curable resin are reacted. In some embodiments, at least partially curing the curable resin means that the gel point of the curable resin, when combined with the thermoplastic composition, has been reached. The gel point refers to the time or temperature at which a cross-linked three-dimensional network begins to form. The gel point can be measured using the rheological evaluations described in the examples below. In some embodiments, the plurality of solid particles gels within a period of 4 to 10 hours after introducing the composition into the wellbore. In some embodiments, the plurality of solid particles gels at least 4, 5, 6, 7, or 8 hours after introducing the composition into the wellbore.

In some embodiments of methods of modifying a wellbore disclosed herein, the method further comprises drilling the wellbore, wherein introducing the composition disclosed herein is carried out during or after drilling the wellbore. Advantageously, the plurality of particles disclosed herein is compatible with a variety of drilling compositions. During the drilling process, if an unconsolidated zone or a fracture in the formation is detected, the rotation of the drill can be stopped, and a composition disclosed herein comprising the plurality of solid particles can be introduced to the wellbore without removing the drill or flushing out the drilling fluid. Once the plurality of particles reaches the target depth, it typically will cure to form the plug. Once the plug is formed, drilling can be resumed through the plug to reach deeper zones of the formation.

Methods according to the present disclosure can be used in vertical wells, deviated wells, inclined wells or horizontal wells and may be useful for oil wells, gas wells, and combinations thereof.

Exemplary geological formations that may be modified according to the present disclosure include siliciclastic (e.g., shale, conglomerate, diatomite, sand, and sandstone) or carbonate (e.g., limestone) formations. Typically, compositions and methods according to the present disclosure can be used to treat siliciclastic formations. In some embodiments, the geological formation is predominantly sandstone (i.e., at least 50 percent by weight sandstone). Thermoplastic compositions and curable resins may be selected, for example, to have good adhesion to the formation that is modified.

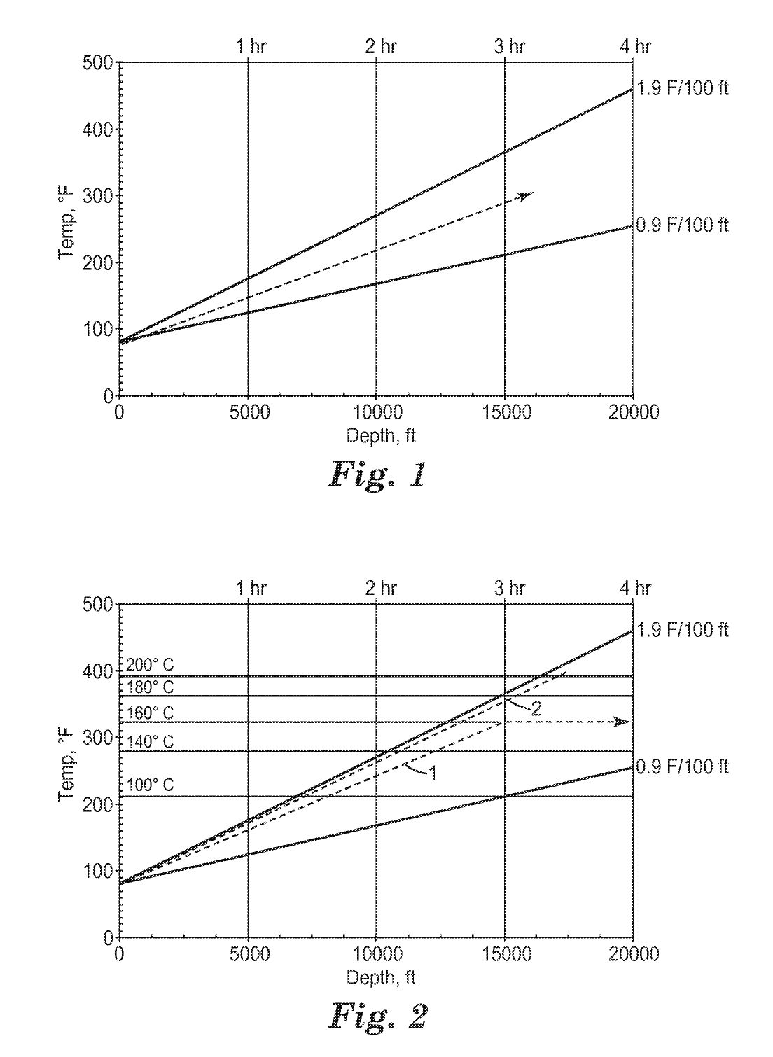

The method of making a plurality of particles according to the present disclosure can be useful, for example, for customizing the plurality of particles or compositions for selected zone of a subterranean formation. Data comprising the target depth and temperature of the zone can be used to generate a formulation comprising a thermoplastic composition and a curable resin. Some typical data comprising the target depth and temperature of a geological formation is shown in FIG. 1, wherein the discontinuous line represents the typical temperature that may be reached at a certain depth. The thermoplastic composition can be selected based at least partially on its softening temperature being below the temperature in the zone, and the formulation is generated based at least partially on its gelling after the target depth is reached.

Compositions and methods disclosed herein may be useful for zones having depths in a range from 3000 feet to 20000 feet. In some embodiments, the zone has a depth in a range from 6000, 7000, 8000, 9000, or 10000 feet up to 20000 feet. In some embodiments of the method of modifying a wellbore within a geological formation disclosed herein, the composition disclosed herein is injected to a depth of at least 10,000 feet. In some of these embodiments, the plurality of solid particles has a gel point above the softening temperature of the thermoplastic composition, and wherein the gel point is achieved after the depth is reached.

The drilling rate and pumping time that can be achieved in the field also provides useful guidance for customizing the composition disclosed herein and may influence how a method of modifying a wellbore disclosed herein is carried out. For example, the drilling rate and pumping time can be used to determine when a composition disclosed herein should be injected into the wellbore, so that it can reach the desired depth before the gel point of the plurality of solid particles.

### Selected Embodiments of the Disclosure

In a first embodiment, the present disclosure provides a composition comprising a fluid;

a plurality of solid particles dispersed in the fluid, wherein the plurality of solid particles comprises a thermoplastic composition having a softening temperature in a range from 50° C. to 180° C. and a curable resin, wherein optionally at least some of the particles in the plurality of solid particles comprise both the thermoplastic composition and the curable resin, and wherein the solid particles have an average aspect ratio of less than 2:1.

In a second embodiment, the present disclosure provides the composition according to the first embodiment, wherein the thermoplastic composition comprises a thermoplastic polymer with a functional group that is reactive with the curable resin.

In a third embodiment, the present disclosure provides the composition according to the second embodiment, wherein thermoplastic polymer comprises at least one of an amine, a carboxylic acid, or a hydroxyl group.

In a fourth embodiment, the present disclosure provides the composition according to any preceding embodiment, wherein the curable resin is a solid epoxy resin. In a fifth embodiment, the present disclosure provides the composition according to any preceding embodiment, wherein the thermoplastic composition comprises at least one of a polyurethane, a polyamide, a polyester, a polycarbonate, a polylactic acid, an acrylic, a polyimide, or an ionomer.

In a sixth embodiment, the present disclosure provides the composition according to any preceding embodiment, wherein at least some of the particles in the plurality of solid particles comprise both the thermoplastic composition and the curable resin.

In a seventh embodiment, the present disclosure provides the composition according to the sixth embodiment, wherein the thermoplastic composition and the curable resin form an interpenetrating network.

In an eighth embodiment, the present disclosure provides the composition according to any one of the first to fifth embodiments, wherein the thermoplastic composition and the curable resin are in separate solid particles of the plurality of solid particles.

In a ninth embodiment, the present disclosure provides the composition according to any preceding embodiment, wherein the plurality of solid particles have an average particle size of up to 2 millimeters.

In a tenth embodiment, the present disclosure provides the composition according to any preceding embodiment, wherein the fluid is a drilling fluid comprising hydrocarbons.

In an eleventh embodiment, the present disclosure provides the composition according to the tenth embodiment, wherein the fluid is a drilling fluid comprising a water-in-oil emulsion.

In a twelfth embodiment, the present disclosure provides a method of modifying a wellbore within a geological formation, the method comprising:

introducing the composition according to any preceding embodiment into the wellbore;

subjecting the thermoplastic composition to a temperature above its softening temperature; and

at least partially curing the curable resin to form a plug in the wellbore.

In a thirteenth embodiment, the present disclosure provides the method according to the twelfth embodiment, wherein introducing the composition comprises introducing the composition to a depth of at least 10,000 feet.

In a fourteenth embodiment, the present disclosure provides the method according to the thirteenth embodiment, wherein the plurality of solid particles gels above the softening temperature of the thermoplastic composition, and wherein the plurality of solid particles gels after the depth is reached.

In a fifteenth embodiment, the present disclosure provides the method according to any one of embodiments 12 to 14, further comprising drilling the wellbore, wherein introducing the composition is carried out during or after drilling the wellbore.

In a sixteenth embodiment, the present disclosure provides the method according to the fifteenth embodiment, wherein any fractures formed during drilling the wellbore are filled by the plug in the wellbore.

In a seventeenth embodiment, the present disclosure provides the method according to embodiment 15 or 16, wherein drilling is carried out at a drilling rate, and wherein the drilling rate is used to determine when to introduce the composition.

In an eighteenth embodiment, the present disclosure provides the method according to any one of embodiments 12 to 17, wherein the formation comprises sandstone.

In a nineteenth embodiment, the present disclosure provides the method according to the fourteenth embodiment, wherein the plurality of solid particles gels within a period of 4 to 10 hours after introducing the composition into the wellbore.

In a twentieth embodiment, the present disclosure provides a method of making a plurality of particles, the method comprising:

selecting a zone of a geological formation to be drilled, the zone having a target depth and a temperature;

receiving data comprising the target depth and the temperature of the zone of the geological formation;

generating a formulation comprising a thermoplastic composition and a curable resin, wherein the thermoplastic composition is selected based at least partially on its softening temperature being below the temperature in the zone, and wherein the formulation is generated based at least partially on its gelling after the target depth is reached; and

making the plurality of particles according to the formulation, wherein at least a portion of the plurality of particles comprises the thermoplastic composition, wherein at least a portion of the plurality comprises the curable resin.

Advantages and embodiments of this disclosure are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Softening Temperature

The softening temperatures of the thermoplastic compositions were determined using a stress-controlled rheometer (Model AR2000 manufactured by TA Instruments, New Castle, Del.) according to the following procedure.

The thermoplastic material was placed between two 20 mm parallel plates of the rheometer and pressed to a gap of 2 mm ensuring complete coverage of the plates. A sinusoidal frequency of 1 Hz at 1% strain was then applied over a temperature range of 60-200° C. The resistance force of the molten resin to the sinusoidal strain was proportional to its modulus which was recorded by a transducer and displayed in graphical format. Using rheometeric software, the modulus is mathematically split into two parts: one part that was in phase with the applied strain (elastic modulus—solid-like behavior), and another part that was out of phase with the applied strain (viscous modulus—liquid-like behavior). The temperature at which the two moduli were identical (cross-over temperature) was defined as a softening temperature, as it represents the temperature above which the resin began to behave predominantly like a liquid.

### Example 1

The example materials (i.e., first and second materials) were each separately compounded using an 18 mm twin screw extruder with an L/D ratio of 15 manufactured by Thermo Fisher Scientific Inc., Waltham, Mass. The processing was at a temperature of 160° C. and an rpm of 120. A capillary die with a diameter of 6.35 mm and a L/D ratio of 32 was attached to the end of the extruder and fed the extrudate into an ice/water bath of approximately 0° C. for rapid cooling. The cooled extrudate was then guided into a pelletizer to form 3 mm cylindrical pellets.

The first material included 50% by weight of a thermoplastic polyurethane obtained from Huntsman, The Woodlands, Tex. under the trade designation “IROGRAN A80 P4699”, 30% by weight of a high temperature hot melt adhesive obtained from 3M Company, St. Paul, Minn. under the trade designation “3M SCOTCH-WELD HOT MELT ADHESIVE 3789”, 20% by weight of a polyoxymethylene obtained from Ticona, Morristown, Tenn. under the trade designation “CELCON FG40U01”, and with 10% by weight (based on the total weight of the thermoplastic polyurethane, the hot melt adhesive, and the polyoxymethylene) of an amine curing agent obtained from Air Products, Allentown, Pa., under the trade designation “ANCAMINE 2337S”.

The softening temperature of the first material, without the amine curing agent, was measured according to the test method described above and found to be 82° C. The softening temperature of the first material, with the amine curing agent, was measure according to the test method described above and found to be 58° C.

The second material included 60% by weight of an epoxy resin obtained from Hexion Specialty Chemicals, Houston, Tex., under the trade designation “EPON 2004”, 30% by weight of a polyurethane obtained from Huntsman under the trade designation “IROGRAN A80 P4699”, and 10% by weight of a polyolefin obtained from ExxonMobil Chemical, Houston, Tex. under the trade designation “EXACT 8230”.

For Example 1, the pellets of the first and second materials were combined in a 50/50 weight ratio.

### Example 2

Example 2 was prepared according to the method of Example 1 except the pellets of the first and second materials were combined in a 75/25 weight ratio.

### Example 3

Example 3 was prepared according to the method of Example 1 except the pellets of the first and second materials were combined in a 25/75 weight ratio.

Dynamic moduli were measured for Examples 1 to 3 as a function of time at a constant temperature of 140° C., 150° C., 160° C., and 180° C. using a stress-controlled rheometer (Model AR2000 manufactured by TA Instruments, New Castle, Del.) according to the following procedure.

The thermoplastic material was placed between two 20 mm parallel plates of the rheometer and pressed to a gap of 2 mm ensuring complete coverage of the plates. A sinusoidal frequency of 1 Hz at 1% strain was then applied at the temperature shown in Table 1, below. The resistance force of the molten resin mixture to the sinusoidal strain was proportional to its modulus which was recorded by a transducer and displayed in graphical format. Using rheometeric software, the modulus is mathematically split into two parts: one part that was in phase with the applied strain (elastic modulus—solid-like behavior), and another part that was out of phase with the applied strain (viscous modulus—liquid-like behavior). The time at which the two moduli were identical (cross-over point) was defined as a gel time, as it represents the temperature above which the resin began to behave predominantly like a solid because of curing.

TABLE 1

| | Gel Times in Minutes at Various Temperatures | | | |
|---|---|---|---|---|
| Example | 140° C. | 150° C. | 160° C. | 180° C. |
| 1 | none | none | 115 | 25 |
| 2 | Not measured | Not measured | 115 | Not measured |
| 3 | Not measured | Not measured | 75 | Not measured |

FIG. 2 is a chart of the temperature profile expected for the plurality of particles of Example 1 plotted against a typical wellbore temperature profile at different depths, pumping times, and drilling rates. As illustrated by discontinuous line 1, if the target depth and temperature is 15,000 feet and 160° C., respectively, the particles can be transported and placed before gelling occurs. Once the particles are in place, gelling will occur after an additional 115 minutes. As illustrated by discontinuous line 2, if the target depth is greater than 17,500 feet, and the temperature is 180° C., the particles may reach the gel point before the target temperature is reached.

### Adhesion Evaluation of Pellets

A small amount of Example 1 pellets (approximately 1 gram) was sandwiched between two circular sections of sandstone (obtained from Cleveland Quarries, Vermillion, Ohio, under the trade designation “BEREA SANDSTONE”). The two circular sections were wrapped in aluminum foil and clamped together. The resulting specimen was heated in an oven at 160° C. for 3 hours and then allowed to cool to room temperature overnight. The two circular sections were impossible to separate by hand. This procedure was repeated using the same type of sandstone, where the sandstone had been wet with tap water before the Example 1 pellets were applied. To wet the sandstone, it was placed under running tap water until all the surface area was visibly wet. After heating the sample as described above, the two circular sections were impossible to separate by hand.

### Adhesion Evaluation of Powder

The Example 1 pellets were ground using a cryo-grinder to a size range of 200 to 3000 microns. A cube of tan sandstone obtained from The Briar Hill Stone Co., Glenmont, Ohio, with dimensions 2 inches by 2 inches by 2 inches (5.1 cm by 5.1 cm by 5.1 cm) was drilled to form a hole through the cube having a 1-inch (2.5 cm) diameter. The drilled cube was then cut into three sections, each having a 1-inch diameter hole. The bottom section was filled with the ground powder, which was pressed down to mitigate the fluffiness of the powder. Some powder was placed on top of the section (separated by washers having a height of 1 mm) before the next section was placed on top of it. The procedure was repeated before the top section was placed to complete the specimen, which was wrapped in aluminum foil, clamped together, and heated in an oven at 160° C. for 3 hours and then allowed to cool to room temperature. The specimen was cut in half and the hardness of the exposed adhesive was measured using a durometer available from Instron, Norwood, Mass., under the trade designation “SHORE DUROMETER”, scale D. Ten hardness measurements were taken to provide an average of 43 and a standard deviation of 6. The procedure was repeated using a heating time in the oven of 6 hours, and the resulting hardness was 47±4.

### Sand Consolidation

A mixture of sand (obtained from Badger Mining Corp., Berlin, Wis., under the trade designation “BADGER FRAC HYDRAULIC FRACTURING SAND”, 20/40 grade) and the powder made from Example 1 pellets was prepared in a weight ratio of 2:1. Greased brass molds were filled with the mixture and then covered with a greased stainless steel plate. The molds were heated in an oven at 160° C. for 3 hours and then allowed to cool to room temperature. The sample was removed from the mold, and no loose sand was observed. The procedure was repeated using an oven heating time of 6 hours, and again, no loose sand was observed.

Foreseeable modifications and alterations of this disclosure will be apparent to those skilled in the art without departing from the scope and spirit of this disclosure. This invention should not be restricted to the embodiments that are set forth in this application for illustrative purposes.

1. A composition comprising
a fluid;
a plurality of solid particles dispersed in the fluid, wherein the plurality of solid particles comprises a thermoplastic composition having a softening temperature in a range from 50° C. to 180° C. and a curable resin, wherein optionally at least some of the particles in the plurality of solid particles comprise both the thermoplastic composition and the curable resin, and wherein the solid particles have an average aspect ratio of less than 2:1.

2. The composition according to claim 1, wherein the thermoplastic composition comprises a thermoplastic polymer with a functional group that is reactive with the curable resin.

3. The composition according to claim 2, wherein thermoplastic polymer comprises at least one of an amine, a carboxylic acid, or a hydroxyl group, and wherein the curable resin is a solid epoxy resin.

4. The composition according to claim 1, wherein the thermoplastic composition comprises at least one of a polyurethane, a polyamide, a polyester, a polycarbonate, a polylactic acid, an acrylic, a polyimide, or an ionomer.

5. The composition according to claim 1, wherein at least some of the particles in the plurality of solid particles comprise both the thermoplastic composition and the curable resin.

6. The composition according to claim 5, wherein the thermoplastic composition and the curable resin form an interpenetrating network.

7. The composition according to claim 1, wherein the thermoplastic composition and the curable resin are in separate solid particles of the plurality of solid particles.

8. The composition according to claim 1, wherein the fluid is a drilling fluid comprising hydrocarbons.

9. The composition according to claim 8, wherein the fluid is a drilling fluid comprising a water-in-oil emulsion.

10. A method of modifying a wellbore within a geological formation, the method comprising:
introducing the composition according to claim 1 into the wellbore;
subjecting the thermoplastic composition to a temperature above its softening temperature; and
at least partially curing the curable resin to form a plug in the wellbore.

11. The method according to claim 10, wherein introducing the composition comprises introducing the composition to a depth of at least 10,000 feet, wherein the plurality of solid particles gels above the softening temperature of the thermoplastic composition, and wherein the plurality of solid particles gels after the depth is reached.

12. The method according to claim 10, further comprising drilling the wellbore, wherein introducing the composition is carried out during or after drilling the wellbore.

13. The method according to claim 12, wherein any fractures formed during drilling the wellbore are filled by the plug in the wellbore.

14. The method according to claim 12, wherein drilling is carried out at a drilling rate, and wherein the drilling rate is used to determine when to introduce the composition.

15. A method of making a plurality of particles, the method comprising:
selecting a zone of a geological formation to be drilled, the zone having a target depth and a temperature;
receiving data comprising the target depth and the temperature of the zone of the geological formation;
generating a formulation comprising a thermoplastic composition and a curable resin, wherein the thermoplastic composition is selected based at least partially on its softening temperature being below the temperature in the zone, and wherein the formulation is generated based at least partially on its gelling after the target depth is reached; and
making the plurality of particles according to the formulation, wherein at least a portion of the plurality of particles comprises the thermoplastic composition, wherein at least a portion of the plurality comprises the curable resin.

16. The method of claim 10, wherein the formation comprises sandstone.

17. The method of claim 10, wherein the plurality of solid particles gels above the softening temperature of the thermoplastic composition, and wherein the plurality of solid particles gels after the depth is reached.

18. The method of claim 17, wherein the plurality of solid particles gels within a period of 4 to 10 hours after introducing the composition into the wellbore.

19. The composition according to claim 7, wherein thermoplastic polymer comprises at least one of an amine, a carboxylic acid, or a hydroxyl group, and wherein the curable resin is a solid epoxy resin.

20. The composition according to claim 7, wherein the thermoplastic composition comprises at least one of a polyurethane, a polyamide, a polyester, a polycarbonate, a polylactic acid, an acrylic, a polyimide, or an ionomer.
